(19) United States
(12) Patent Application Publication
(10) Pub. No.: US 2025/0209154 A1
(43) Pub. Date: Jun. 26, 2025

(54) MANAGEMENT OF MULTIPLE RECEIVED SECURITY NOTIFICATIONS FOR A SINGLE TRANSACTION

(71) Applicant: MOTOROLA MOBILITY LLC, WILMINGTON, DE (US)

(72) Inventors: AMIT KUMAR AGRAWAL, BANGALORE (IN); VIJAYPRAKASH IDLUR, IDLUR (IN); PANDURANGA REDDY PAILLA, NALGONDA (IN)

(21) Appl. No.: 18/392,811

(22) Filed: Dec. 21, 2023

(51) Int. Cl. G06F 21/55

(52) U.S. Cl. CPC G06F 21/552; G06F 2221/034

(57) ABSTRACT

A method provides techniques for identifying a most-recently received security notification from amongst multiple received security notifications for a single transaction. The method includes detecting, by a processor of an electronic device, receipt within a predetermined time interval of a plurality of security notifications, where each security notification contains different transaction authentication information. The method includes determining that each of the plurality of notifications are associated with a same transaction. The method includes identifying a most recently received notification. The method continues with modifying at least one characteristic of each other notification from the plurality of notifications that is not the most recently received notification to create a modified notification that includes an indication that corresponding transaction authentication data is obsolete.

### BACKGROUND

### 1. Technical Field

The present disclosure generally relates to portable electronic devices, and more specifically to portable electronic devices that support receiving security notifications.

### 2. Description of the Related Art

Modern portable electronic devices, such as smartphones and tablet computers, can provide a myriad of features. These features can include text-based communication features, such as sending and receiving text messages (also known as short message service or SMS), and secure electronic/online account login support features, such as Multi-Factor Authentication (MFA), which provides an additional layer of security beyond traditional username and password combinations. The role of text messages in MFA involves using a mobile device to receive a one-time verification code, adding an extra step to the account access authentication process. In MFA, users are required to provide two or more factors to authenticate themselves. The first factor is usually something the user knows (e.g., a password), and the second factor is something the user has or is provided by the computer system implementing the MFA. In many situations, data provided via a text message serve as a second factor that is communicated to the user's mobile device whose phone number or text ID is associated with the electronic account being accessed. Thus, when a user attempts to log in to the electronic account, a one-time passcode is sent to the user's mobile device via text message. The one-time passcode code is valid for a short period and is used in conjunction with the login password to complete the authentication process to access the account.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components used to enable the device to manage receipt of multiple security notifications for a single transaction, according to one or more embodiments;

FIG. 2 illustrates an example of multiple received security notifications received at the communication device and which are subsequently managed by the communication device, according to one or more embodiments;

FIG. 3 illustrates an example user interface of a communication device indicating obsolete transaction authentication information via use of a localized obsolete tag, according to one or more embodiments;

FIG. 4 illustrates another example user interface of a communication device indicating obsolete transaction authentication information by rendering the obsolete notification using a different background fill color, according to one or more embodiments;

FIG. 5 illustrates another example of multiple received security notifications presented on a display of communication device with secure account information redacted, according to one or more embodiments;

FIG. 6A illustrates another example of utilizing localized tags to indicate and obscure obsolete transaction authentication information and to obscure the secure account information presented in the obsolete notifications, according to one or more embodiments;

FIG. 6B illustrates an example notification window of an electronic device in which obsolete transaction authentication information is automatically removed from the notification window contemporaneously with receipt and presentation of a new notification, according to one or more embodiments;

FIG. 7 depicts a flowchart of a method for identifying a most-recently received security notification from amongst multiple received security notifications for a single transaction, according to one or more embodiments; and

FIG. 8 depicts a flowchart of an additional method for identifying a most-recently received security notification from amongst multiple received security notifications for a single transaction, according to one or more embodiments.

### DETAILED DESCRIPTION

According to aspects of the present disclosure, an electronic device, a method, and a computer program product provides techniques for detecting, by a processor of an electronic device, receipt within a predetermined time interval of a plurality of security notifications, where each security notification contains different transaction authentication information. A determination is made that each of the plurality of security notifications are associated with a same transaction. A most recently received notification from the plurality of security notifications is identified. At least one characteristic of each other earlier received notification from the plurality of security notifications that is not the most recently received notification is modified to create a modified notification that includes an indication that an included transaction authentication information is obsolete.

There are many applications today that utilize MFA with a one-time passcode (OTP) sent via text message to a user's mobile device. These applications can include, but are not limited to, ecommerce applications, banking applications, social media applications, email and messaging applications, video streaming applications, travel reservation applications, ticket sales applications, and more. Thus, the OTP is an essential part of enabling access to many services that people use on a daily basis. One challenge that can arise when using MFA includes delays caused by network issues on the network used for delivering transaction authentication information, such as a one-time passcode (OTP). For example, the network that is used for the delivery of transaction authentication information can include a cellular network. Due to network congestion and/or disruptions, it is possible that an OTP may not arrive timely, or may not arrive at all. To mitigate OTP delivery issues, many applications allow a convenient reissuing of a request for an OTP. While the reissuing can help in certain cases, the reissue can also create an additional problem. As an example, when OTPs are delayed due to network congestion, the text messages containing OTPs can arrive in a burst once the network congestion is resolved. Each text message contains a different OTP. For security purposes, in most cases, as soon as a new OTP is requested, any previous OTPs are invalidated. The end result is that there can be many text messages, each including a different OTP, shown on an electronic device (such as a mobile phone) that are associated with a user. In most cases, all but the newest OTP is obsolete. However, it can be challenging for a user to identify which OTP is the correct one to use. The confusion can lead to the user entering an incorrect OTP, which can have adverse effects such as wasting time, having the user potentially getting locked out of his/her account, and losing out on certain time bound offers such as flash sales, due to delays in gaining account access.

The disclosed embodiments alleviate the aforementioned issues caused by the receipt of multiple OTP messages generated for a single transaction. According to the disclosure, incoming text messages are analyzed to determine if the text messages contain transaction authentication information such as a one-time passcode. Additional metadata such as the source of the message and/or other metadata items from within the text message may also be identified and analyzed. When it is determined that multiple text messages contain, or likely contain, transaction authentication information associated with a same transaction, all of the multiple text messages with the exception of the newest (i.e., most recent in terms of time generated) text message is indicated as being obsolete and/or is removed/deleted from the display and/or device. Thus, the user can easily identify the most recent text message that contains the transaction authentication information needed to perform the associated transaction. Accordingly, disclosed embodiments can provide improvements that simplify the use of MFA, which increases the likelihood that users continue to have reliable secured access to their accounts using MFA.

One or more embodiments can include an electronic device including: a display; a memory having stored thereon at least one notification application and a security notification management (SNM) module; a network interface which enables the electronic device to connect to, and receive security notification data from, at least one second electronic device; and a processor communicatively coupled to the display, the memory, and the network interface. The processor executes program code of the security notification management module, which enables the electronic device to: detect receipt, within a predetermined time interval, of a plurality of security notifications, where each security notification contains different transaction authentication information; determine that each of the plurality of security notifications are associated with a same transaction; identify a most recently received notification from the plurality of security notifications; and modify at least one characteristic of each other earlier received notification from the plurality of security notifications that is not the most recently received notification to create a modified notification that includes an indication that an included transaction authentication information is obsolete.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

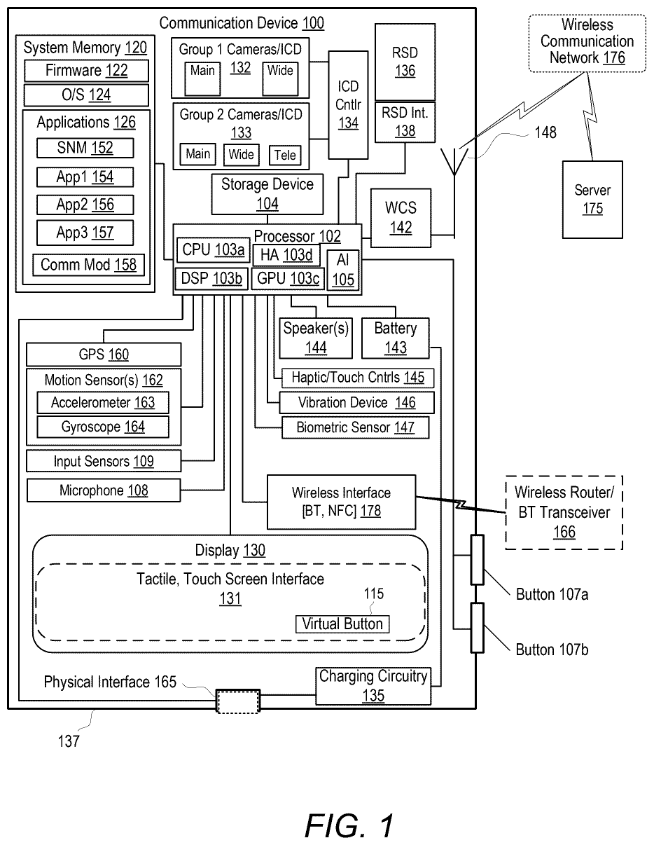

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to identify a most-recently received security notification from amongst multiple received security notifications for a single transaction, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Controller 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the disclosure, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, security notification management (SNM) module 152, other applications, indicated as 154, 156 and 157, and communication module 158. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, security notification management (SNM) module 152 includes program instructions for identifying and processing text messages containing transaction authentication information.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more of the applications (e.g., 152, 154, 156, 158) and specifically security notification management (SNM) module 152 stored thereon. Processor 102 can access RSD 136 to provision electronic device 100 with program code that, when executed/processed by processor 102, the program code causes or configures processor 102 and/or generally electronic device 100, to provide the various security notification management functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be coupled to charging circuitry 135 and device battery 143 to enable recharging of device battery 143.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, which can be similarly connected to wireless communication network 176. In one or more embodiments, various functions that are being performed on communications device 100 can be supported using or completed via/on server 175.

Electronic device 100 can also wirelessly communicate, via wireless interface(s) 178, with wireless communication network 176 via communication signals transmitted by short range communication device(s). Wireless interface(s) 178 can be a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In one or more embodiments, WCS 142 with antenna(s) 148 and wireless interface(s) 178 collectively provide wireless communication interface(s) of electronic device 100.

The electronic device 100 of FIG. 1 is only a specific example of devices that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

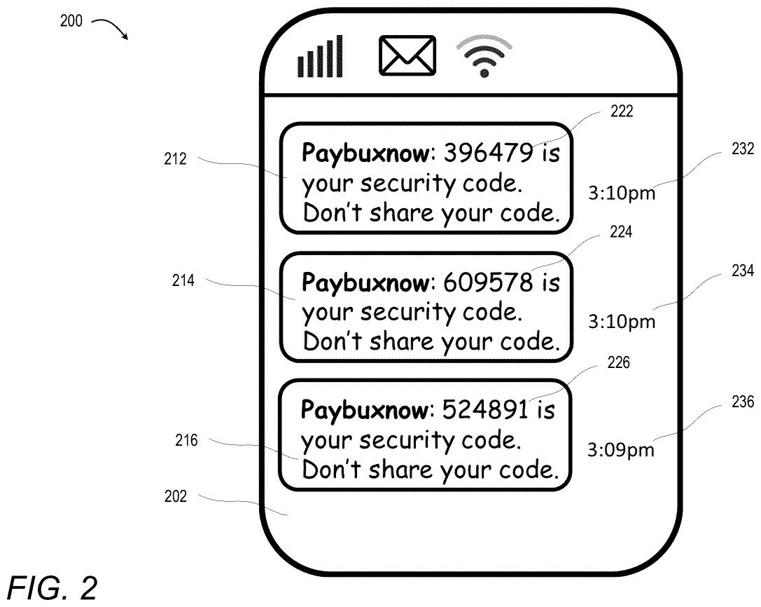

FIG. 2 illustrates an example of multiple received security notifications received at the communication device and which are subsequently managed by the communication device, according to one or more embodiments. As shown in FIG. 2, device 200 presents multiple received security notifications that are associated with a same transaction and generated in time sequence within a time window threshold (e.g., 90 seconds). Device 200 includes a display 202 on which multiple security notifications are displayed. Device 200 can be an implementation of electronic device 100, having similar components and/or functionality. As shown in FIG. 2, three text messages are shown, indicated as message 212, message 214, and message 216. Each message (212, 214, and 216) is a security notification, and each security notification contains different transaction authentication information. Message 216 includes transaction authentication information 226, in the form of a one-time passcode having a value of 524891. Message 214 includes transaction authentication information 224, in the form of a one-time passcode having a value of 609578. Message 212 includes transaction authentication information 222, in the form of a one-time passcode having a value of 396479. In one or more embodiments, an arrival time for each message may also be shown. Accordingly, message 216 has an arrival time of 3:09 pm, as indicated by reference 236. Message 214 has an arrival time of 3:10 pm, as indicated by reference 234. Message 212 also has an arrival time of 3:10 pm, as indicated by reference 232. In the example of FIG. 2, a user may have requested an OTP three times for a same verification transaction/process. In one embodiment, the three requests can have been made within the 90 second time window threshold. In the example of FIG. 2, message 212 is the newest message to arrive, and accordingly, message 214 and message 216 contain obsolete transaction authentication information. If a user attempts to use transaction authentication information 226 or transaction authentication information 224, the user will be denied access, and may risk getting locked out of his/her account.

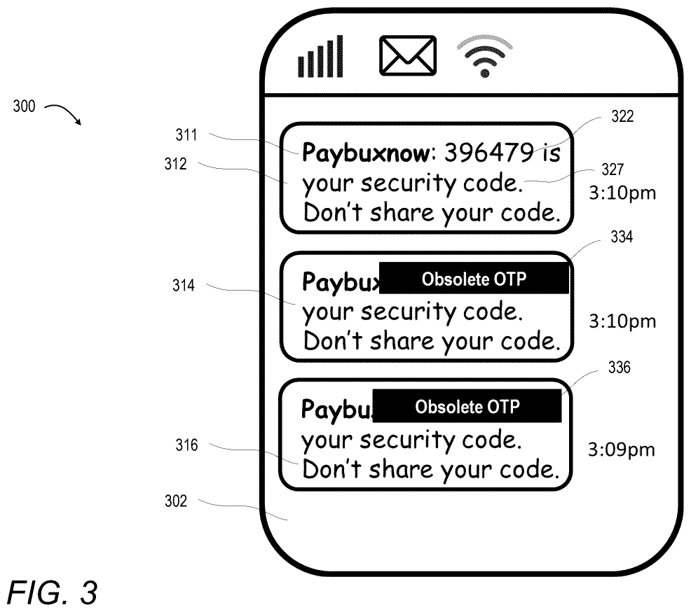

FIG. 3 illustrates an example user interface of a communication device indicating obsolete transaction authentication information via use of a localized obsolete tag, according to one or more embodiments. Device 300 includes a display 302 on which multiple security notifications are displayed. Device 300 can be an implementation of electronic device 100, having similar components and/or functionality. As shown in FIG. 3, three text messages are shown, indicated as message 312, message 314, and message 316. Each of the text messages 312, 314, and 316, have a common source (e.g., are sent from a common server identifier (ID)). In one or more embodiments, the messages 312, 314, and 316 are security notifications that are displayed in time sequence, with the most recently received security notification shown in the topmost position (message 312). A processor within electronic device 300, executing code from a security notification management (SNM) module 152, identifies that the three messages 312, 314, and 316 originate from the same source (e.g., same source identifier/number), and have all arrived within a predetermined time interval (e.g., each of the three messages 312, 314, and 316, have arrived within a 90 second time period). Accordingly, electronic device 300 creates modified notifications for message 314 and message 316, where the modified notification includes an indication that the transaction authentication information included in the message is obsolete. More specifically, message 314 includes indication 334 that obscures the transaction authentication information contained within message 314. Similarly, message 316 includes indication 336 that obscures the transaction authentication information contained within message 316. The processor within electronic device 300, executing code from a security notification management (SNM) module 152, identifies that message 312 is the newest message from amongst the messages from the common source that contain OTP information.

In one or more embodiments, the transaction authentication information is a one-time passcode. The one-time passcode can include a numeric string. The information can include the presence of a numeric string, such as indicated at 322. The information can include the presence of a sender name that indicates an online account system, such as indicated at 311. The information can include a source telephone number associated with the message. Other information can be used in addition to, or instead of, the aforementioned information, in one or more embodiments. In this way, disclosed embodiments can distinguish a burst of text messages containing transaction authentication information, from other text messages that can arrive in a burst, such as text messages from a friend. One or more embodiments can include presenting each received notification of the plurality of security notifications in time sequence, with each other earlier received notification visibly presenting the indication of being obsolete. One or more embodiments can include monitoring for receipt of a next security notification within the predetermined time interval, and in response to receiving a next security notification during the predetermined time interval, automatically marking a previously received security notification as obsolete. In one or more embodiments, a first security notification is deemed to be obsolete when a newer security notification arrives, where the newer security notification is associated with the same transaction as the first security notification.

In one or more embodiments, various pieces of information may be used for determining that a text message contains transaction authentication information. The information can include a sender name, one or more words within the text message, and/or other information. In one or more embodiments, each incoming message is parsed and/or processed to determine if it is a security notification that contains a one-time-passcode (OTP). One-time passcodes are commonly used during transactions involving financial operations, such as bank account transfers, ecommerce purchases, and so on. In one or more embodiments, a token analysis process is performed, in which the messages are tokenized, and one or more tokens from the message are inspected to determine if the message is a security notification that includes an OTP. As an example, message 312 includes tokens of a sender name 311, a numeric code 322 adjacent to the sender name 311, and also contains the word ‘code’ at 327 as a token. In one or more embodiments, the processor determines if a notification contains a one-time-passcode (OTP) or other transaction authentication information, and analyzes the notification accordingly, to determine if the notification is obsolete, based on arrival of newer notifications pertaining to the same transaction. Some embodiments may utilize additional and/or alternative techniques for identifying a security notification containing an OTP, such as machine learning, natural language processing, and/or other suitable techniques.

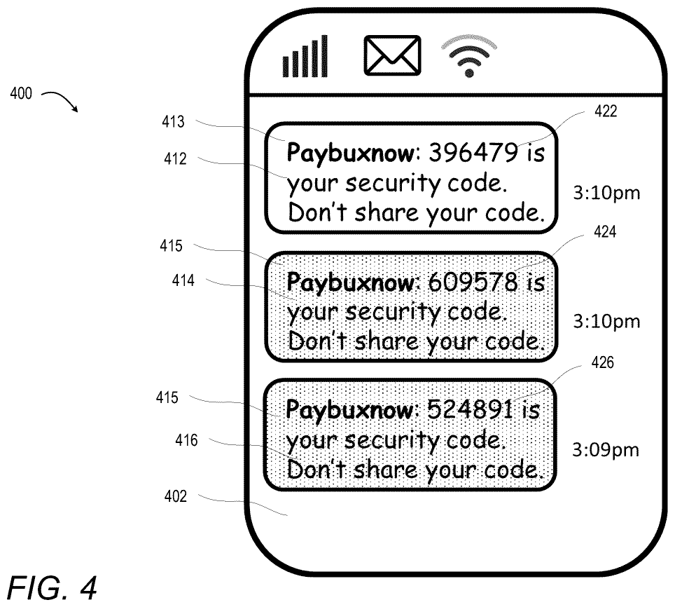

FIG. 4 illustrates another example user interface of a communication device indicating obsolete transaction authentication information by rendering the obsolete notification using a different background fill color, according to one or more embodiments. Device 400 includes a display 402 on which multiple security notifications are displayed. Device 400 can be an implementation of electronic device 100, having similar components and/or functionality. As shown in FIG. 4, three text messages are shown, indicated as message 412, message 414, and message 416. Each of the messages 412, 414, and 416, have a common source. In the example of FIG. 4, message 412 contains current transaction authentication information, while message 414 and message 416 contain obsolete transaction authentication information. However, unlike the embodiment shown in FIG. 3, with the embodiment shown in FIG. 4, the transaction authentication information for each message is still visible. That is, numeric string 426 is rendered within message 416, numeric string 424 is rendered within message 414, and numeric string 422 is rendered within message 412. A processor within electronic device 400, executing code from a security notification management (SNM) module 152, identifies that the three messages 412, 414, and 416 originate from the same source (e.g., same telephone number), and have all arrived within a predetermined time interval (e.g., each of the three messages 412, 414, and 416, have arrived within a 90 seconds time period). Accordingly, electronic device 400 creates modified notifications for message 414 and message 416, where the modified notification includes an indication that included transaction authentication information is obsolete. More specifically, message 414 and message 416 are rendered with the background fill color indicated at 415. Conversely, message 412, which is the newest message, is rendered with a different background fill color, indicated at 413. In this way, a user can quickly identify which of the displayed messages is likely to contain current information, and which of the displayed messages are likely to contain obsolete information. As an example, the background fill color indicated at 413 can be white, while the background fill color indicated at 415 can be gray, thereby providing a visual cue for the user to quickly identify the obsolete security notifications.

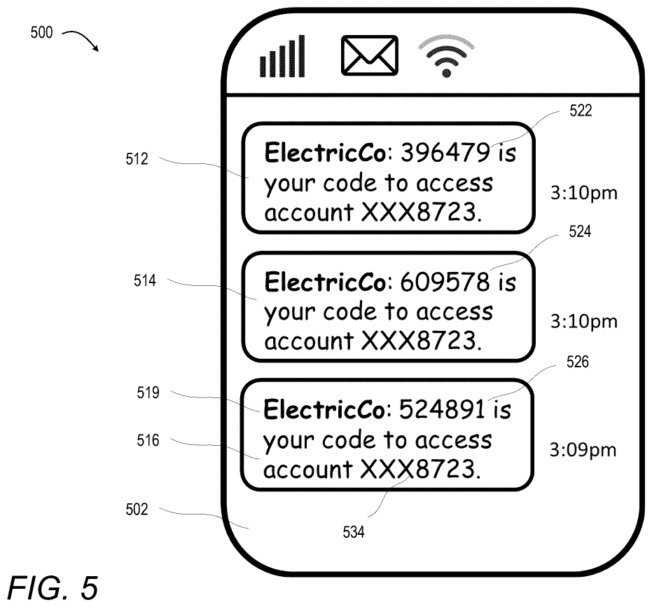

FIG. 5 illustrates another example of multiple received security notifications presented on a display of communication device with secure account information redacted, according to one or more embodiments. Device 500 includes display 502 on which multiple security notifications are displayed. Device 500 can be an implementation of electronic device 100, having similar components and/or functionality. As shown in FIG. 5, three text messages are shown, indicated as message 512, message 514, and message 516. Message 516 includes transaction authentication information 526, in the form of a one-time passcode having a value of 524891. Message 514 includes transaction authentication information 524, in the form of a one-time passcode having a value of 609578. Message 512 includes transaction authentication information 522, in the form of a one-time passcode having a value of 396479.

Message 516 includes a sender string that indicates an online account system, as indicated at 519. Moreover, message 516 further contains account number information, indicated as 534. Message 514 and message 512 contain the same account number information as message 516, and the same online account system sender string as message 516. In one or more embodiments, the sender string is used as a criterion to determine if multiple messages correspond to a same transaction. Accordingly, one or more embodiments can utilize one or more metadata items to identify one or more text messages as belonging to a same transaction. One or more embodiments can include identifying one or more metadata items within each of the plurality of security notifications, and determining, based on the one or more metadata items, that at least two of the plurality of security notifications correspond to a single transaction.

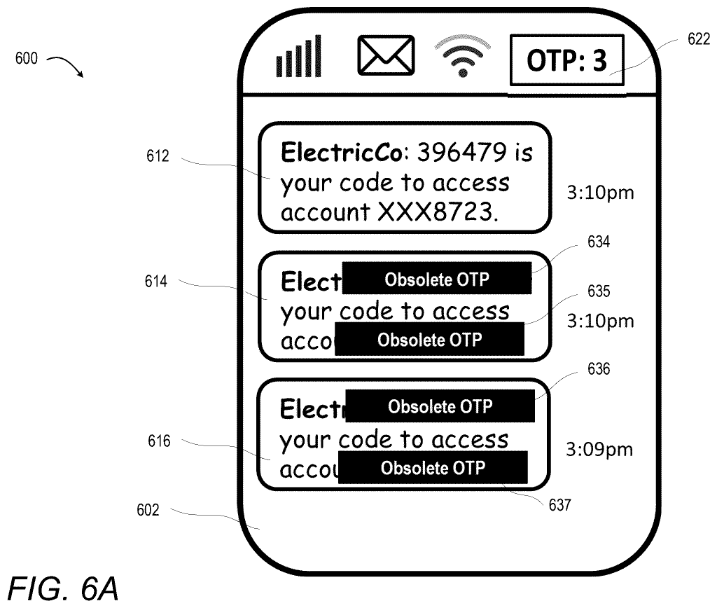

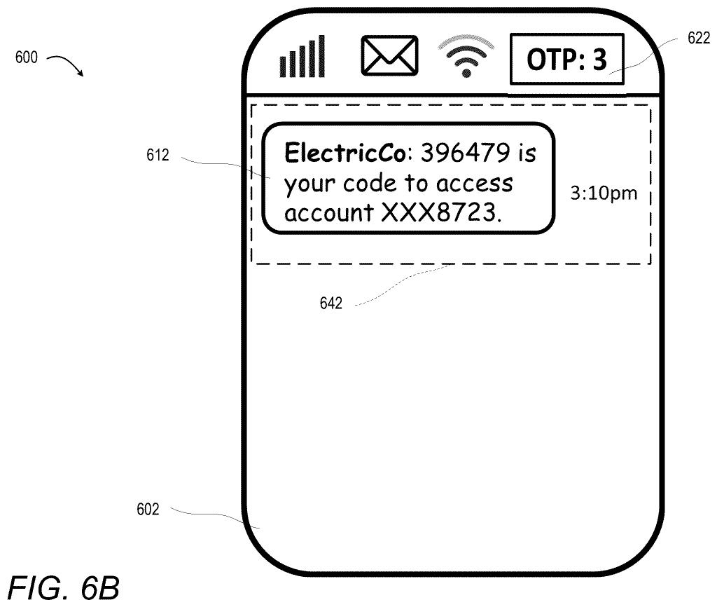

FIG. 6A illustrates another example of utilizing localized tags to indicate and obscure obsolete transaction authentication information and to obscure the secure account information presented in the obsolete notifications, according to one or more embodiments. Device 600 includes a display 602 on which multiple security notifications are displayed. Device 600 can be an implementation of electronic device 100, having similar components and/or functionality. As shown in FIG. 6, three text messages are shown, indicated as message 612, message 614, and message 616. More specifically, message 614 includes indication 634 that obscures the transaction authentication information contained within message 614, and an additional indication 635 that obscures additional metadata within message 614. Similarly, message 616 includes indication 636 that obscures the transaction authentication information contained within message 614, and an additional indication 637 that obscures additional metadata within message 614. A benefit of obscuring the obsolete information is that the obscuring prevents the obsolete information from being used.

In one or more embodiments, the processor of the electronic device 600 keeps a count of how many security notifications corresponding to a same transaction have been received. Device 600 displays the count of notifications from the plurality of security notifications that correspond to the single transaction. In one or more embodiments, this count is displayed in the OTP received message count indicator 622. In one or more embodiments, for each received text message that contains transaction authentication information determined to be associated with a same transaction, the count value (shown as 3 in OTP received message count indicator 622), is incremented. In one or more embodiments, the count value can be cleared manually by a user (e.g., by double-tapping on the OTP received message count indicator 622). Alternatively, in one or more embodiments, the count value can be cleared automatically after a predetermined time period (e.g., following ten minutes after a last text message containing transaction authentication information was received).

In the example shown in FIG. 6A, there are three messages shown, with two of the messages (message 614 and message 616) indicated as containing obsolete information, whereas message 612 does not have any indications as being obsolete, and therefore, is subject to being interpreted as a current message. Referring again to the OTP received message count indicator 622, a value of 3 is presented, indicating that three OTP messages have been received for the same transaction. However, the user knows how many times he/she has requested an OTP. If the user is aware that he/she requested an OTP four times, then the user knows to not use message 612, and to wait for another OTP to arrive. Thus, the feature of the OTP received message count indicator 622 provides an added benefit of reducing the risk of using obsolete transaction authentication information, even in cases where the text message containing the particular transaction authentication information is not marked as obsolete. One or more embodiments can include displaying a number that indicates a number of notifications from the plurality of security notifications that correspond to the single transaction.

FIG. 6B illustrates an example notification window of an electronic device in which obsolete transaction authentication information is automatically removed from the notification window contemporaneously with receipt and presentation of a new notification, according to one or more embodiments. In the embodiment of FIG. 6B, device 600 includes a display 602 on which only the most recently received text message containing transaction authentication information for a given transaction is shown. Older messages are not shown in a notification window 642 on the display 602, as compared with FIG. 6A, in which case the older messages (message 614 and message 616) are still shown. In one or more embodiments, the notification window 642 can include a subset of the total area of the display 602, in which new notifications are displayed. One or more embodiments can include presenting only the most recently received notification on a display in response to receipt of an input that triggers presenting received notifications. One or more embodiments can include sequentially removing, from a notification window of the electronic device, each other earlier received notification from the plurality of security notifications, concurrently with receipt of a next security notification for the same transaction. In one or more embodiments, the messages that are removed from the notification window 642 may be deleted from the device 600. Thus, one or more embodiments can include, deleting from the electronic device, each other earlier received notification from the plurality of security notifications, subsequent to receiving a next security notification for the same transaction.

The embodiment of FIG. 6B also includes the OTP received message count indicator 622. The OTP received message count indicator 622 shows how many text messages corresponding to a same transaction have been received within a predetermined time interval. The OTP received message count indicator 622 is particularly useful in this embodiment since only the most recently received message 612 is shown. However, if the user knows he/she requested more than three OTP for completion of an MFA transaction, then the user can infer from the OTP received message count indicator 622 to wait for additional text messages to arrive before attempting to complete the MFA transaction using the received transaction authentication information.

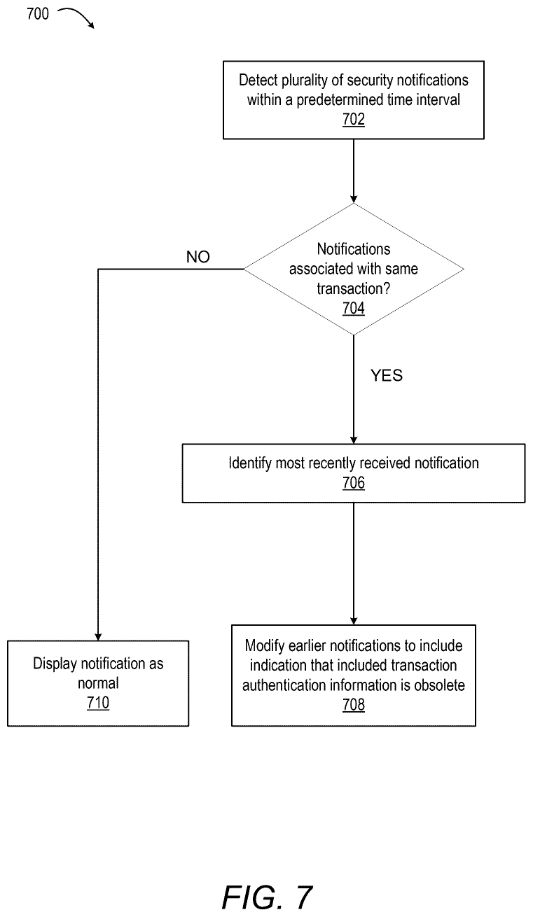

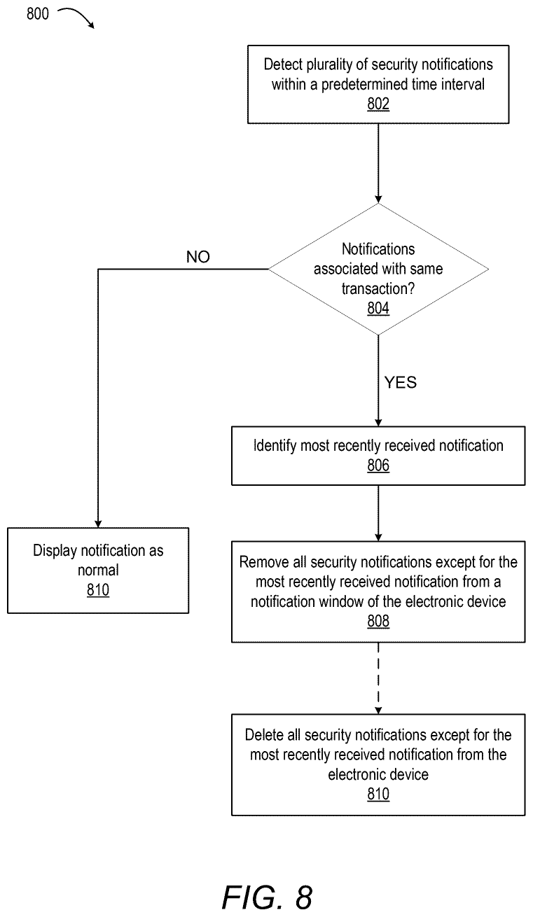

Referring now to the flowcharts presented by FIG. 7 and FIG. 8, the descriptions of the methods in FIG. 7 and FIG. 8 are provided with general reference to the specific components and features illustrated within the preceding FIGS. 1-6B. Specific components referenced in the methods of FIG. 7 and FIG. 8 may be identical or similar to components of the same name used in describing preceding FIGS. 1-6B. In one or more embodiments, processor 102 (FIG. 1) configures electronic device 100 (FIG. 1) to provide the described functionality of the methods of FIG. 7 and FIG. 8 by executing program code for one or more modules or applications provided within system memory 120 of electronic device 100, including security notification management (SNM) module 152 (FIG. 1).

FIG. 7 depicts a flowchart of method 700 for identifying a most-recently received security notification from amongst multiple received security notifications for a single transaction, according to one or more embodiments. The method 700 starts at block 702, where a plurality of security notifications within a predetermined time interval are detected. The detection can include parsing text within a received message to identify one or more keywords (e.g., words such as “code,” “passcode,” and the like). The detection can include identifying text corresponding to an online account, such as the name of a service or business (e.g., a financial institution). In one or more embodiments, the detection can include utilizing machine learning techniques, such as natural language processing (NLP) to identify a received message as being a security notification that includes transaction authentication information, such as a one-time passcode (OTP), a time-sensitive URL (uniform resource locator), and/or other transaction authentication information. The URL may lead to a webpage or contain a specific token that needs to be submitted by a user in order to gain access to an account. The method 700 continues to block 704, where a check is made to determine if the received notifications are associated with a same transaction. As an example, if a user performs a first MFA to access his VPN, and then immediately performs a second MFA to access his banking information, then two text messages may be received in close temporal proximity, but the first received text message is associated with VPN access, and the second received text message is associated with a bank account. Accordingly, in the aforementioned example, the two text messages are associated with two different transactions. If, at block 704, it is determined that the received notifications are not associated with a same transaction, then the method 700 continues to block 710, where the notifications are displayed as normal, with no indication of obsolete information. Referring again to the aforementioned example of VPN access followed by banking system access, the two received text messages are identified as security notifications, but as the two security notifications are associated with different transactions (VPN access and banking system access), the method 700 continues to block 710.

In a second example, if a user attempts to log in to her email account, and the account is set up with MFA that utilizes a one-time passcode sent via text message, then the user requests a text message to be sent to her electronic device (e.g., smartphone) as part of the log in process. If, after 30 seconds, she still has not received the expected text message, she may opt to request a new OTP to be sent. With a congested network, these messages may be delayed, and then, once the network congestion is resolved, multiple text messages may be received within a short duration of time (burst). In one or more embodiments, the short duration of time may be in the range of 30 seconds to 300 seconds. Other durations are possible in one or more embodiments. The multiple messages may be associated with a same transaction based on the presence of a sender name that indicates an online account system, such as indicated at 311 of FIG. 3. Additional information may also be used for making the determination at block 704. The information can include, but is not limited to including, a time of day that each message was received, a source (sender) telephone number associated with each message, a webpage that is currently rendered in a browser on the electronic device, an application (app) that is currently opened/running on an electronic device, and so on.

If, at block 704, it is determined that multiple received security notifications are associated with a same transaction, then the method 700 continues to block 706, where a most recently received notification is identified. In one or more embodiments, each message may have a sending time associated with the message as part of associated metadata. In other embodiments, the electronic device may append a received time for each message as associated metadata for each received message. The method 700 then continues to block 708, where earlier security notifications are modified to indicate that included transaction authentication information is obsolete. In one or more embodiments, the indication can include changing the background fill color of a message, such as shown in FIG. 4. In one or more embodiments, the indication can be overlaid on the message, such as indicated in FIG. 3 and FIG. 6A.

FIG. 8 depicts a flowchart of an additional method for identifying a most-recently received security notification from amongst multiple received security notifications for a single transaction, according to one or more embodiments. Within method 800, blocks 802, 804, 806, and 810 are similar to corresponding blocks described for method 700 shown in FIG. 7. The method 800 starts at block 802, where a plurality of security notifications within a predetermined time interval are detected. The method 800 continues to block 804, where a check is made to determine if the received notifications are associated with a same transaction. If, at block 804, it is determined that the received notifications are not associated with a same transaction, then the method 800 continues to block 810, where the notifications are displayed as normal, with no indication of obsolete information. If, at block 804, it is determined that multiple received security notifications are associated with a same transaction, then the method 800 continues to block 806, where a most recently received notification is identified.

The method 800 then proceeds to block 808, where all security notifications except for the most recently received notification from a notification window of the electronic device are removed from being displayed. In one or more embodiments, only the most recently received text message that includes transaction authentication information is shown on the device display. An example of the removal of all security notifications, except for the most recently received notification from a notification window of the electronic device is depicted in FIG. 6B. Optionally, the method 800 may continue to block 810, where all security notifications except for the most recently received notification are deleted from the electronic device. Deleting old messages helps free up valuable storage space on the electronic device. As messages accumulate over time, they can take up a significant amount of storage, potentially affecting the performance of an electronic device. Moreover, having fewer messages to store can significantly speed up the backup process. Reducing the number of text messages on a device by deleting the obsolete security notifications is particularly relevant when transferring data or setting up a new device. Furthermore, automatically deleting the obsolete security notifications can help save data and bandwidth when syncing or backing up text messages to cloud storage.

As can now be appreciated, disclosed embodiments provide techniques for management of multiple received security notifications for a single transaction. Received messages are analyzed to determine if the messages are security messages that are associated with a common transaction. A common occurrence for receiving multiple security messages that are associated with a common transaction happens when a first requested OTP is delayed due to network congestion, poor signal, and/or other factors. A user may then request additional OTPs. Once the additional security notifications are received, disclosed embodiments identify and analyze metadata to determine if the received messages are associated with a same transaction. If multiple received messages associated with a same transaction are received, disclosed embodiments indicate which messages are older, and which message is the newest, increasing the probability that a user will choose the correct transaction authentication information for completing an MFA transaction. Moreover, disclosed embodiments provide an OTP received message count indicator to further assist a user in keeping track of how many security notifications have been received, enabling the user to compare the number from the OTP received message count indicator with how many times the user has requested an OTP for a given transaction. Thus, disclosed embodiments enable the security benefits of MFA while reducing the risk of authentication failure and/or account lockouts due to using obsolete transaction authentication information. While numerous examples within this disclosure use a one-time passcode as the transaction authentication information, embodiments are not limited to management of OTPs. Other information, such as secure links, sound files, and/or other data can be used to convey transaction authentication information and can be managed by one or more of the disclosed embodiments.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a memory having stored thereon at least one notification application and a security notification management (SNM) module;
a network interface which enables the electronic device to connect to, and receive security notification data from, at least one second electronic device; and
a processor communicatively coupled to the display, the memory, and the network interface, and which executes program code of the security notification management module, which enables the electronic device to:
detect receipt, within a predetermined time interval, of a plurality of security notifications, wherein each security notification contains different transaction authentication information;
determine that each of the plurality of security notifications are associated with a same transaction;
identify a most recently received notification from the plurality of security notifications; and
modify at least one characteristic of each other earlier received notification from the plurality of security notifications that is not the most recently received notification to create a modified notification that includes an indication that an included transaction authentication information is obsolete.

2. The electronic device of claim 1, wherein further, the processor:
presents only the most recently received notification on a display in response to an input that triggers presenting of received notifications.

3. The electronic device of claim 1, wherein further, the processor:
presents each received notification of the plurality of security notifications in time sequence, with each other earlier received notification visibly presenting the indication of being obsolete.

4. The electronic device of claim 1, wherein further, the processor:
sequentially removes, from a notification window of the electronic device, each other earlier received notification from the plurality of security notifications, concurrently with receipt of a next security notification for the same transaction.

5. The electronic device of claim 1, wherein further, the processor:
deletes from the electronic device, each other earlier received notification from the plurality of security notifications, subsequent to receiving a next security notification for the same transaction.

6. The electronic device of claim 1, wherein the processor monitors for receipt of a next security notification within the predetermined time interval, and in response to receiving a next security notification during the predetermined time interval, the processor marks a previously received security notification as obsolete.

7. The electronic device of claim 1, wherein further, the processor:
identifies one or more metadata items within each of the plurality of security notifications; and
determines, based on the one or more metadata items, that at least two of the plurality of security notifications correspond to a single transaction.

8. The electronic device of claim 7, wherein further, the processor renders a number on the display that indicates a number of notifications from the plurality of security notifications that correspond to the single transaction.

9. The electronic device of claim 1, wherein the transaction authentication information is a one-time passcode.

10. A method comprising:
detecting, by a processor of an electronic device, receipt within a predetermined time interval of a plurality of security notifications, wherein each security notification contains different transaction authentication information;
determining that each of the plurality of security notifications are associated with a same transaction;
identifying a most recently received notification from the plurality of security notifications; and
modifying at least one characteristic of each other earlier received notification from the plurality of security notifications that is not the most recently received notification to create a modified notification that includes an indication that an included transaction authentication information is obsolete.

11. The method of claim 10, further comprising presenting only the most recently received notification on a display in response to an input that triggers presenting received notifications is received.

12. The method of claim 10, further comprising presenting each received notification of the plurality of security notifications in time sequence, with each other earlier received notification visibly presenting the indication of being obsolete.

13. The method of claim 10, further comprising sequentially removing, from a notification window of the electronic device, each other earlier received notification from the plurality of security notifications, concurrently with receipt of a next security notification for the same transaction.

14. The method of claim 10, further comprising deleting from the electronic device, each other earlier received notification from the plurality of security notifications, subsequent to receiving a next security notification for the same transaction.

15. The method of claim 10, further comprising:
monitoring for receipt of a next security notification within the predetermined time interval; and
in response to receiving a next security notification during the predetermined time interval, marking a previously received security notification as obsolete.

16. The method of claim 10, further comprising:
identifying one or more metadata items within each of the plurality of security notifications; and
determining, based on the one or more metadata items, that at least two of the plurality of security notifications correspond to a single transaction.

17. The method of claim 16, further comprising displaying a number that indicates a number of notifications from the plurality of security notifications that correspond to the single transaction.

18. The method of claim 10, wherein the transaction authentication information is a one-time passcode.

19. A computer program product comprising a non-transitory computer readable medium having program instructions that when executed by a processor of an electronic device comprising a display, configure the electronic device to perform functions comprising:
detecting, by the processor of the electronic device, receipt within a predetermined time interval of a plurality of security notifications, wherein each security notification contains different transaction authentication information;
determining that each of the plurality of security notifications are associated with a same transaction;
identifying a most recently received notification from the plurality of security notifications; and
modifying at least one characteristic of each other earlier received notification from the plurality of security notifications that is not the most recently received notification to create a modified notification that includes an indication that an included transaction authentication information is obsolete.

20. The computer program product of claim 19, further comprising program instructions for:
identifying one or more metadata items within each of the plurality of security notifications; and
determining, based on the one or more metadata items, that at least two of the plurality of security notifications correspond to a single transaction.
